(19) United States
(12) Patent Application Publication
(10) Pub. No.: US 2020/0225492 A1
(43) Pub. Date: Jul. 16, 2020

(54) SPLIT COMPUTING ARCHITECTURE FOR MANAGING NEAR-EYE-DISPLAY DEVICE CENTER OF GRAVITY

(71) Applicant: Microsoft Technology Licensing, LLC, Redmond, WA (US)

(72) Inventors: Jason P. WILLIAMS, Santa Clara, CA (US); Andriy PLETENETSKYY, Redmond, WA (US); Trevor BOSWELL, Redmond, WA (US); Brandon HARRIS, Redmond, WA (US); Junius PENNY, Redmond, WA (US)

(21) Appl. No.: 16/359,746

(22) Filed: Mar. 20, 2019

Related U.S. Application Data
(60) Provisional application No. 62/791,733, filed on Jan. 11, 2019.

(51) Int. Cl. G02B 27/01; G06F 9/38

(52) U.S. Cl. CPC G02B 27/0176; G06F 9/3877

(57) ABSTRACT

A Near-Eye-Display (NED) device includes a computing architecture that is physically split across multiple locations to ergonomically locate a center of gravity (CG) with respect to a user's head. Subsets of computing components are physically non-contiguous, so their weight is dispersed around a user's head rather than being concentrated in a single location forward of the user's face. This causes the CG of the NED device to be more ergonomically located on the user's head relative to conventional NED devices. Ergonomically locating the CG of the NED device is a direct reduction in the amount of the physical strain that is placed on the user's neck as compared to conventional NED devices—even if the weight of the NED devices in the same.

### PRIORITY APPLICATION

This application claims the benefit of and priority to U.S. Provisional Application No. 62/791,733, filed Jan. 11, 2019, entitled “Split Computing Architecture for Managing Near-Eye-Display Device Center Of Gravity,” the entire contents of which are incorporated herein by reference.

### BACKGROUND

Conventional Near-Eye-Display (NED) devices typically include a variety of computing hardware components that are all mounted forward of a user's face during operation. For example, when a conventional NED device is being worn by the user, it is not uncommon for each of a battery, a central processing unit (CPU), a graphics processing unit (GPU), and various sensors to all be located forward of the user's face. From a component packaging standpoint, it is logical for computing hardware components to be located in close proximity to one another and forward of the user's face. This is because the main purpose of such computing hardware components is to control a display device that is located within the user's field of view.

Each individual one of these computing hardware components inherently has some measurable amount of weight. Therefore, concentrating these hardware components forward of the user's face near the display device is highly undesirable from an ergonomic standpoint. Specifically, such designs result in the center of gravity (CG) of the NED device being significantly forward of the user's coronal plane. The unfortunate result of this CG placement is that a significant amount of strain is placed on the user's neck as the user struggles to support the NED device in an upright position. Even if the weight of a NED device is reduced to less than one pound, a CG location that is significantly forward of the coronal plane will inevitably result in neck strain and discomfort—especially in situations where the NED device is worn for significant durations of time such as in gaming and/or industrial applications.

It is with respect to these and other considerations that the disclosure made herein is presented.

### SUMMARY

Technologies described herein provide for a Near-Eye-Display (NED) device that includes a computing architecture that is physically split between two or more locations in order to ergonomically locate a center of gravity of the NED device with respect to a user's head. Generally described, the computing architecture of the NED device includes various computing hardware components that are separated into two or more subsets. The two or more subsets may be physically non-contiguous so that the weight of the various computing hardware components is dispersed around a user's head rather than being concentrated in a single location forward of the user's face. In this way, the center of gravity (CG) of the NED device can be more ergonomically located with respect to the user's head (e.g., the CG can be closely aligned with a user's coronal plane) than in conventional NED devices in which the bulk of the weight is forward of the user's face. It will be appreciated that the result of ergonomically locating the CG of the NED device is a direct reduction in the amount of the physical strain that is placed on the user's neck as compared to conventional NED devices—even if the weight of the NED devices in the same. Stated plainly, the NED device described herein may be relatively more balanced on the user's head due to the computing components being split up between the front and back of the user's head.

An exemplary NED device includes a computing architecture that is split into at least two subsets of computing hardware components. The individual subsets may be physically non-contiguous with respect to one another. For example, the first subset of the computing hardware components may be located forward of a user's head when the user is wearing the NED device whereas the second subset of the computing hardware components may be located aft of a user's head when the user is wearing the NED device.

Since the exemplary NED device is configured to render imagery within the user's field of view during operation (e.g., to facilitate an augmented or mixed reality experience), the first subset of computing hardware components may include a display device that protrudes into (or is otherwise located within) the user's field of view. An exemplary such display device that may be used in various NED applications is a transparent waveguide display having diffractive optical elements (DOEs) for redirecting light toward a user's eyes. The first subset may also include various other computing hardware components such as, for example, a graphics processing unit (GPU), various types of environmental sensors, and a first logic board to which these computing hardware components are mounted. The second subset of the computing hardware components includes other computing hardware components that, together with the first subset, form a single computing architecture of the exemplary NED device. In various embodiments, the second subset may include at least a central processing unit (CPU), one or more batteries, and a second logic board to which these computing hardware components are mounted.

In the exemplary NED device, the first subset of computing hardware components and the second subset of computing hardware components are communicatively coupled together and form the single computing architecture of the NED device. As used herein, the term “computing architecture” may generally refer to a computing system layout design that defines physical locations for the various computing hardware components included within a NED device in addition to data paths that enable communication between these various computing hardware components. Additionally, in the exemplary NED device, the first subset of computing hardware components and the second subset of computing hardware components are physically coupled together. For example, the exemplary NED device may include a support structure for mounting the NED device onto the user's head and each of the first subset and second subset of computing hardware components may be mechanically mounted to the support structure.

Since the first subset of computing hardware components and the second subset of computing hardware components are also communicatively coupled together, the support structure (that is usable to support the exemplary NED device on the user's head and which physically couples the first and second subsets together) may also least partially enclose a physical data path through which communications (e.g., data signals) are passed between the first subset and the second subset. For example, a cable ribbon that contains a plurality of coaxial cables may extend through an enclosed region of the support structure from the first logic board at the front of the user's head to the second logic board at the back of the user's head. Thus, high speed data signals that would normally be transmitted between layers of a Printed Circuit Board (PCB) are rather transmitted through a support structure (e.g., a head band) that is securely holding the exemplary NED device to the user's head.

These and various other features will be apparent from a reading of the following Detailed Description and a review of the associated drawings. This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### DRAWINGS

The Detailed Description is described with reference to the accompanying figures. In the figures, the left-most digit of a reference number identifies the figure in which the reference number first appears. The same reference numbers in different figures indicate similar or identical items. References made to individual items of a plurality of items can use a reference number with another number included within a parenthetical (and/or a letter without a parenthetical) to refer to each individual item. Generic references to the items may use the specific reference number without the sequence of letters.

FIG. 1 illustrates a side view of a conventional Near-Eye-Display (NED) device having a computing architecture that is made up of a plurality of hardware computing components that are concentrated in a single location (e.g., forward of a user's head).

FIG. 2 illustrates a side view of an exemplary NED device having a computing architecture that is split into at least two subsets of computing hardware components.

FIG. 3 is a rear perspective view of an alternate embodiment of a NED device having a computing architecture.

FIG. 4 illustrates details of an exemplary computing architecture that is split into at least two subsets to distribute the weight of various computing hardware components around a user's head for ergonomically locating a CG of a wearable computing device.

### DETAILED DESCRIPTION

The following Detailed Description describes technologies for providing a split computing architecture for a Near-Eye-Display (NED) device to control a location of a center of gravity (CG) of the NED device. The computing architecture described herein is “split” in the sense that two or more subsets of computing hardware components, which operate together to form a single computing device, are physically non-contiguous. The two or more subsets of computing hardware components may be physically non-contiguous so that the weight of the various computing hardware components is dispersed around a user's head rather than being concentrated in a single location forward of the user's face.

The techniques described herein provide benefits over conventional wearable NED devices for at least the reason that the disclosed NED device has a center of gravity (CG) that is ergonomically located with respect to the user's head. For example, splitting the computing architecture of the NED device as described herein enables a CG to be more closely aligned with a user's coronal plane than is achievable in conventional designs in which the majority of the weight of the various computing components is concentrated forward of the user's face. Even if the weight of two different NED devices in the same, the result of ergonomically locating the CG of one NED device over the other is a direct reduction in the relative amount of the physical strain that is placed on the user's neck. Stated plainly, the NED device described herein may be relatively more balanced on the user's head due to the computing components being split up between the front and back of the user's head.

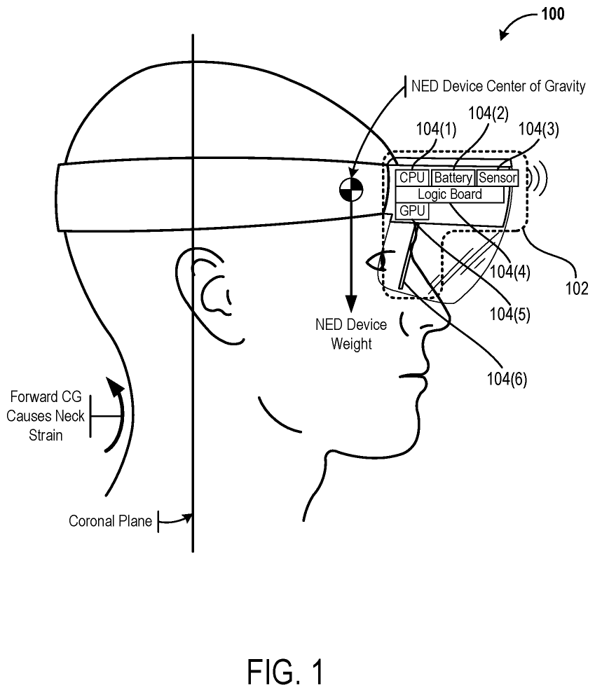

FIG. 1 illustrates a side view of a conventional Near-Eye-Display (NED) device 100 having a computing architecture 102 that is made up of a plurality of communicatively interconnected hardware computing components 104 (also referred to herein as simply “computing component”) that are concentrated in a single location forward of the user's face. As illustrated, the conventional NED device 100 includes six hardware computing components 104 that together form the computing architecture 102. Specifically, in the illustrated example, the conventional NED device 100 includes: a first computing component 104(1)—(illustrated as being a central processing unit (CPU)), a second computing component 104(2)—(illustrated as being a battery), a third computing component 104(3)—(illustrated as being a sensor), a fourth computing component 104(4)—(illustrated as being a logic board), a fifth computing component 104(5)—(illustrated as being a graphics processing unit (GPU)), and a sixth computing component 104(6)—(illustrated as being a display device). It should be appreciated that the discussion of the six computing components is for illustrative purposes only and that many computing architectures will have more than or less than six computing components.

As described above, each of these computing components inherently have some measurable amount of weight and, therefore, concentrating them in a single location is highly undesirable from an ergonomic standpoint. For example, as illustrated in FIG. 1, concentrating the weight of these computing components near the display device which is located in the user's field of view results in the center of gravity (CG) of the NED device being significantly forward of the user's coronal plane. The unfortunate result of this CG placement is that a significant amount of strain is placed on the user's neck as the user struggles to support the NED device in an upright position. Even if the weight of a NED device is reduced to less than one pound, a CG location that is significantly forward of the coronal plane will inevitably result in neck strain and discomfort—especially in situations where the NED device is worn for significant durations of time such as in gaming and/or industrial applications.

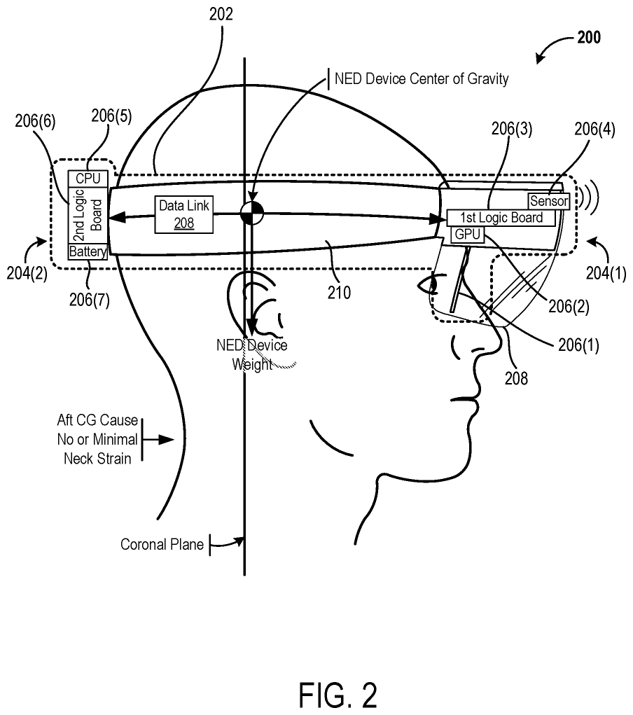

FIG. 2 illustrates a side view of an exemplary NED device 200 having a computing architecture 202 that is split into at least two subsets 204 of computing hardware components 206. As illustrated, the exemplary NED device 200 includes a first subset 204(1) of computing components that is located forward of the user's head and a second subset 204(2) of computing components that is located aft of the user's head. Notwithstanding being physically distributed around the user's head, the various computing components 206 operate in conjunction with one-another together to form the single computing architecture 202. For illustrative purposes, this single computing architecture 202 is outlined in a dashed line.

In various embodiments, the exemplary NED device 200 is configured to render computer generated images (CGIs) in front of a user's eye(s). For example, the exemplary NED device 200 can be used for augmented reality (AR) and/or virtual reality (VR) applications. In implementations where the exemplary NED device 200 is an AR Head Mounted Device (HMD) device, a display component may be a transparent display element that enables the user to see concurrently both the real-world environment surrounding her as well as AR content generated by the display component. The exemplary NED device 200 may further include a visor 208 that is configured to protect one or both of the user's eyes and/or the display component (labeled as 206(1)) when the exemplary NED device 200 is being worn by the user during operation.

In the specific but non-limiting example as illustrated, the first subset 204(1) of computing components within the exemplary NED device 200 includes a first computing component 206(1)—(illustrated as being a display device), a second computing component 206(2)—(illustrated as being a graphics processing unit (GPU)), a third computing component 104(3)—(illustrated as being a 1^{st} logic board), and a fourth computing component 206(4)—(illustrated as being a sensor). Exemplary display devices that may be used in various NED applications include, but are not limited to, a transparent waveguide display having diffractive optical elements (DOEs) for redirecting light toward a user's eyes, a Liquid Crystal Display (LCD) device, curved mirror type optical systems, and/or any other suitable display device whether currently existing or subsequently developed.

As further illustrated in this specific but non-limiting example, the second subset 204(2) of computing components within the exemplary NED device 200 includes a fifth computing component 206(5)—(illustrated as being a central processing unit (CPU)), a sixth computing component 206(6)—(illustrated as being a 2^{nd} logic board), and a seventh computing component 104(7)—(illustrated as being a battery). As used herein, the term “logic board” may be used interchangeably with the term “motherboard.” An exemplary such logic board may be a printed circuit board (PCB)—either rigid, flexible, or semi-flexible—onto which various computing components may be mounted into connectors to establish communications links between such computing components.

As illustrated, the first subset 204(1) that includes the first computing component 206(1) through the fourth computing component 206(4) is physically non-contiguous with the second subset 204(2) that includes the fifth computing component 206(5) through the seventh computing component 206(7). Specifically, in the illustrated but non-limiting embodiment, when the user is properly wearing the NED device 200 as shown if FIG. 2, the first subset 204(1) of computing components within the exemplary NED device 200 is located forward of a user's head whereas the second subset 204(2) of computing components within the exemplary NED device 200 is located aft of a user's head. Thus, the inherent weight of each of the first computing component 206(1) through the fourth computing component 206(4) is located forward of the user's head and the inherent weight of each of the fifth computing component 206(5) through the seventh computing component 206(7) is located aft of the user's head. In this way, the weight of the various components is ergonomically dispersed around the user's head rather than being concentrated forward of the user's face. It will be appreciated that the split computing architecture results in the exemplary NED device being balanced on the user' head.

As shown in FIG. 2, the first subset 204(1) of computing hardware components are communicatively coupled to the second subset 204(2) of computing hardware components via a data link so as to form the single computing architecture of the NED device 200. As used herein, the term “computing architecture” may generally refer to a system layout design that defines physical locations for the various computing hardware components included within a NED device in addition to data paths that enable communication between these various computing hardware components. As illustrated, the NED device includes a physical data link 208 to enable the computing components of the first subset 204(1) to communicate with the other computing components of the second subset 204(2). In some embodiments, the physical data link 208 may be physically plugged into a socket at each end. For example, the physical data link 208 may be plugged into a first socket on the 1^{st} logic board and also plugged into a second socket on the 2^{nd} logic board. Exemplary physical data links 208 include, but are not limited to, multi-conductor micro-coaxial cable assemblies. As a specific but nonlimiting example, the physical data link 208 may be a matched-impedance multi-conductor cable assembly that is in a ribbon form.

Additionally, in the exemplary NED device 200, the first subset 204(1) of computing hardware components and the second subset 204(2) of computing hardware components are physically coupled together by a support structure 210. As illustrated, the support structure 210 is a rigid or semi-rigid support structure that is configured for mounting the NED device 200 onto the user's head. When the NED device 200 is properly mounted onto the user's head, the first subset 204(1) of computing components is securely positioned at the front of the user's head with the display device (e.g., labeled 206(1) in this example) protruding into the user's field of view. In this way, the NED device 200 can render CGIs within the user's field of view to augment the user's perception of the real-world environment. At the same time, the second subset 204(2) of computing components is securely positioned at the rear of the user's head. Thus, by virtue of having the split computing architecture as described herein, the center of gravity (CG) of the exemplary NED device 200 is substantially more aligned with the user's coronal plane as compared to the conventional NED device 100.

As described above, the support structure 210 (that is usable to support the exemplary NED device 200 on the user's head and which physically couples the first and second subsets together) may also least partially enclose a data path 208 through which communications (e.g., data signals) are passed between the first subset 204(1) of computing components and the second subset 204(2) of computing components. For example, a cable ribbon that contains a plurality of coaxial cables may extend through an enclosed region of the support structure 210 from the first logic board at the front of the user's head to the second logic board at the back of the user's head. Thus, high speed data signals that would normally be transmitted between layers of a Printed Circuit Board (PCB) are rather transmitted through a support structure (e.g., a head band) that is securely holding the exemplary NED device 200 to the user's head.

It can be appreciated that since the NED device 200 is configured to render imagery within the user's field of view during operation, practical design considerations will likely dictate that the display device be included within the first subset 204(1) that is located in front of the user's head. This may enable the display device to efficiently protrude into (or otherwise be displaced within) the user's field of view. Since the display device is included within the first subset 204(1), in some implementations, one or more graphics processing units (GPUs) may also be included within the first subset 204(1) to minimize the physical separation between the display device and the GPU—as compared to other computing components 206 that are included within the second subset 204(2). In some embodiments, latency between the GPU and the display device is reduced by physically locating the GPU proximate to (e.g., within the same subset 204) to the display device.

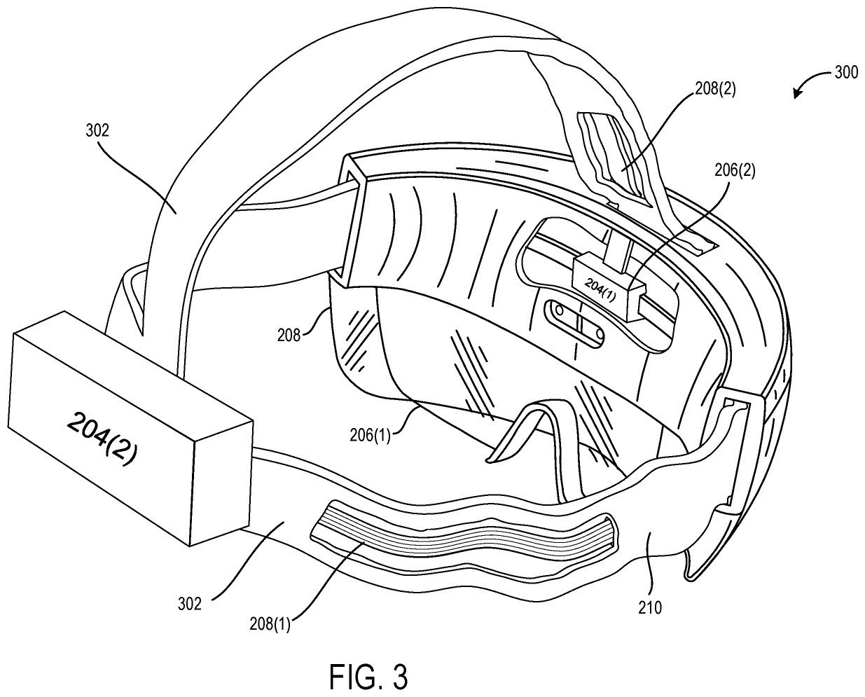

Turning now to FIG. 3, a rear perspective view is shown of an alternate embodiment of a NED device 300 having a computing architecture that is split into at least two subsets 204 of computing hardware components 206. As illustrated, the NED device 300 includes a support structure having one or more flexible straps 302 to support the NED device 300 on a user's head. Here, the flexible straps 302 have the physical data link 208 embedded therein to transfer high speed data signals between the first subset 204(1) of computing components and the second subset of computing components.

In some embodiments, the physical data link 208 may be embedded within a portion of the support structure 210 that extends along a side of the user's head when the NED device 300 is being worn by the user. For example, as illustrated, the NED device 300 includes a first physical data link 208(1) that is physically embedded within a side portion of the support structure. For illustrative purposes, the support structure 210 is illustrated with a “cut-away” portion that has been removed so as to visually expose the physical data link 208(1). Additionally, or alternatively, the physical data link may be physically embedded within a top portion of the support structure that extends over the top of the user's head when the NED device 300 is being worn by the user. For example, as illustrated, the NED device 300 includes a second physical data link 208(2) that is physically embedded within a top-portion (which is also illustrated with a “cutaway”) that extends over the top of the head.

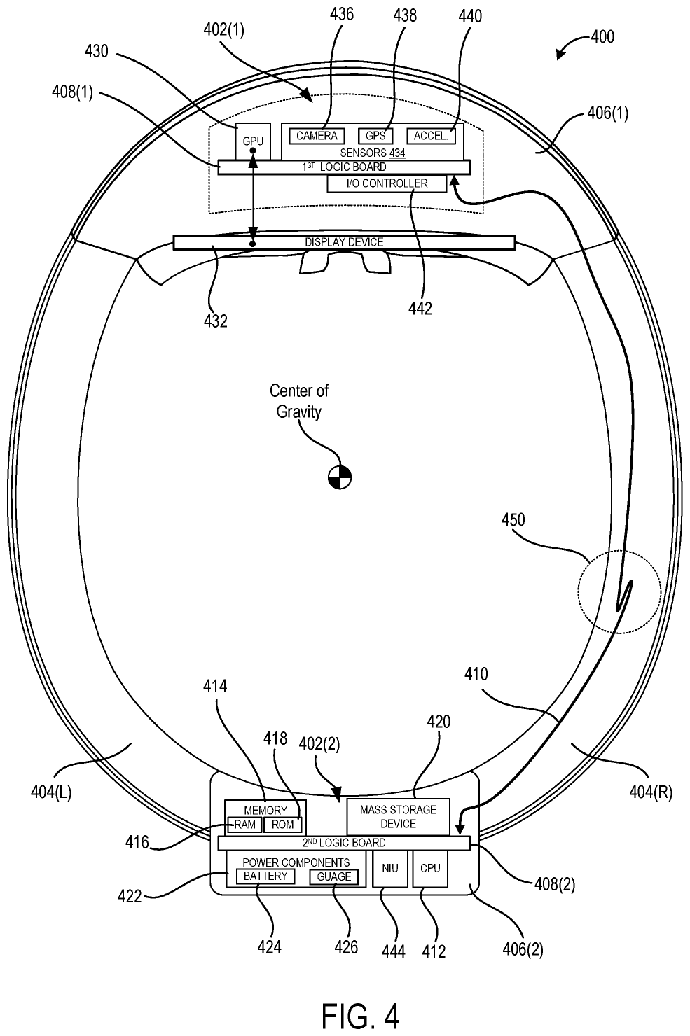

FIG. 4 illustrates details of an exemplary computing architecture 400 that is split into at least two subsets 204 to distribute the weight of various computing hardware components around a user's head for ergonomically locating a CG of a wearable computing device. The computing architecture 400 illustrated in FIG. 4 shows a computing architecture for a NED device. The computing architecture 400 may be used to balance the weight of a wearable computing device on a user's body in a variety of other contexts.

The computing architecture 400 illustrated in FIG. 4 includes a first subset of computing components 402(1) and a second subset of computing components 402(2). The first subset of computing components 402(1) is mechanically coupled to the second subset of computing components 402(2) via a support structure 404. In some embodiments, the support structure 404 is made from a rigid structural plastic or metal and is formed to include an internal cavity that extends from a first housing 406(1) to a second housing 406(2). The first subset of computing components 402(1) is at least partially enclosed within the first housing 406(1) and the second subset of computing components 402(2) is at least partially enclosed within the second housing 406(2).

In some embodiments, the support structure 404 may be at least partially rigid so as to maintain a separation between the first subset of computing components 402(1) and a second subset of computing components 402(2). For example, the support structure 404 may maintain a separation of greater than five inches between the two subsets of computing components, greater than six inches between the two subsets of computing components, greater than seven inches between the two subsets of computing components, greater than eight inches between the two subsets of computing components, or greater than nine inches between the two subsets of computing components, and so on.

In some embodiments, the NED device may have an overall center of gravity (that results from all components of the NED device, not just computing components) that is located at least some predetermined distance from each of the subsets of computing components. For example, the NED device may have an overall center of gravity that is located at least one inch away from the first subset of computing components, at least two inches away from the first subset of computing components, at least three inches away from the first subset of computing components, at least four inches away from the first subset of computing components, or at least five inches away from the first subset of computing components. Additionally, or alternatively, the NED device may have an overall center of gravity that is located at least one inch away from the second subset of computing components, at least two inches away from the second subset of computing components, at least three inches away from the second subset of computing components, at least four inches away from the second subset of computing components, or at least five inches away from the second subset of computing components.

As illustrated, the first subset of computing components 402(1) includes a first logic board 408(1) and the second subset of computing components 402(2) includes a second logic board 408(2). The first logic board 408(1) is communicatively coupled to the second logic board 408(2) via a data link 210 such as, for example, a cable ribbon that contains a plurality of coaxial cables. Thus, high speed data signals that would normally be transmitted between layers of a Printed Circuit Board (PCB) are rather transmitted through a support structure (e.g., a head band) that is securely holding the exemplary NED device to the user's head.

As illustrated, the second subset of computing components 402(2) includes a central processing unit 412 (“CPU”), a system memory 414, including a random-access memory 416 (“RAM”) and a read-only memory (“ROM”) 415. As illustrated, the second logic board 408(2) couples the memory 414 to the CPU 412. A basic input/output system containing the basic routines that help to transfer information between elements within the computer architecture 400, such as during startup, is stored in the ROM 418. The computer architecture 400 may further include a mass storage device 420 for storing an operating system, and one or more application programs.

The CPU 412 is configured to process data, execute computer-executable instructions of one or more application programs, and communicate with other components of the computing device architecture 400 in order to perform various functionality described herein. The CPU 412 may be utilized to execute aspects of the software components presented herein and, particularly, those that utilize, at least in part, a touch-enabled input.

In some configurations, the CPU 412 is, or is included in, a system-on-chip (“SoC”) along with one or more of the other components described herein below. For example, the SoC may include the CPU 412, one or more of the network connectivity components, and one or more of sensor components 434. In some configurations, the CPU 412 is fabricated, in part, utilizing a package-on-package (“PoP”) integrated circuit packaging technique. The CPU 412 may be a single core or multi-core processor.

The CPU 412 may be created in accordance with an ARM architecture, available for license from ARM HOLDINGS of Cambridge, United Kingdom. Alternatively, the CPU 412 may be created in accordance with an x86 architecture, such as is available from INTEL CORPORATION of Mountain View, Calif. and others. In some configurations, the CPU 412 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The mass storage device 420 is connected to the CPU 412 through a mass storage controller (not shown) that is also connected to the second logic board 408(2). The mass storage device 420 and its associated computer-readable media provide non-volatile storage for the computer architecture 400. Although the description of computer-readable media contained herein refers to a mass storage device, such as a solid-state drive, a hard disk or CD-ROM drive, it should be appreciated by those skilled in the art that computer-readable media can be any available computer storage media or communication media that can be accessed by the computer architecture 400.

As illustrated, the second subset of computing components 402(2) includes power components 422 such as, for example, a one or more batteries 424, which can be connected to a battery gauge 426. The batteries 426 may be rechargeable or disposable. Rechargeable battery types include, but are not limited to, lithium polymer, lithium ion, nickel cadmium, and nickel metal hydride. Each of the batteries may be made of one or more cells.

The battery gauge 426 can be configured to measure battery parameters such as current, voltage, and temperature. In some configurations, the battery gauge 426 is configured to measure the effect of a battery's discharge rate, temperature, age and other factors to predict remaining life within a certain percentage of error. In some configurations, the battery gauge 426 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components may also include a power connector, which may be combined with one or more of the Input/Output (I/O) components such as, for example, a Universal Serial Bus (USB) connector. The power components may interface with an external power system or charging equipment via a power I/O component.

As illustrated, the first subset of computing components 402(1) includes a graphics processing unit (GPU) 430 that is dedicated to performing various computing operations/calculations as required to cause a display device 432 to render imagery within a field of view of a user. The display is an output device configured to present information in a visual form. In particular, the display may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display is a liquid crystal display (“LCD”) utilizing any active or passive matrix technology and any backlighting technology (if used). In some configurations, the display is a waveguide display (“LCD”) utilizing diffractive optical elements (DOEs) to directed re-light toward a user.

In some embodiments, the GPU 430 is configured to accelerate operations performed by the CPU 412, including, but not limited to, operations performed by executing general-purpose scientific and/or engineering computing applications, as well as graphics-intensive computing applications such as high-resolution video (e.g., 720P, 1080P, and higher resolution), video games, three-dimensional (“3D”) modeling applications, and the like. In some configurations, the CPU 412 is configured to communicate with the GPU 430 via two physically non-contiguous logic boards 408 that are communicatively coupled via a physical data link 410 that passes through a support structure that is specifically configured to support the computing architecture 400 on the head of a user. In some embodiments, the physical data link 410 includes at least one folded region 450 at which the physical data link 410 is arranged into one or more folds in order to allow a length of the support structure 404 to be adjusted to fit to a user's head. In any case, the CPU and GPU may be configured in accordance with a co-processing CPU/GPU computing model, wherein the sequential part of an application executes on the CPU and the computationally-intensive part is accelerated by the GPU.

Since the NED device of FIG. 4 is configured to render imagery within the user's field of view during operation, the display device 432 is included within the first subset of computing components that is located in front of the user's head. This may enable the display device to efficiently protrude into (or otherwise be displaced within) the user's field of view. Since the display device is included within the first subset, the GPU is also included within the first subset to minimize the physical separation between the display device and the GPU—as compared to other computing components that are included within the second subset. Thus, latency between the GPU and the display device may be minimized by physically locating the GPU proximate to (e.g., within the same subset) to the display device.

As illustrated, the first subset of computing components 402(1) also includes one or more sensors 434. The one or more sensors 434 may include a camera 436 that is configured to capture imagery of a real-world environment surrounding a user that is wearing the illustrated wearable NED device. The camera 436 can be configured to capture still images and/or video. The camera may utilize a charge coupled device (“CCD”) or a complementary metal oxide semiconductor (“CMOS”) image sensor to capture images. In some configurations, the camera includes a flash to aid in taking pictures in low-light environments. Settings for the camera may be implemented as hardware or software buttons.

The one or more sensors 434 may also include a Global Positioning System sensor (“GPS sensor”) 438. The GPS sensor 438 is configured to receive signals from GPS satellites for use in calculating a location. The location calculated by the GPS sensor 438 may be used by any application program that requires or benefits from location information. For example, the location calculated by the GPS sensor 438 may be used with a navigation application program to provide directions from the location to a destination or directions from the destination to the location. Moreover, the GPS sensor 438 may be used to provide location information to an external location-based service, such as E911 service. The GPS sensor 438 may obtain location information generated via WI-FI, WIMAX, and/or cellular triangulation techniques utilizing one or more of network connectivity components to aid the GPS sensor 438 in obtaining a location fix. The GPS sensor 438 may also be used in Assisted GPS (“A-GPS”) systems.

The one or more sensors 434 may also include an accelerometer 440. The accelerometer 440 is configured to measure proper acceleration. In some configurations, output from the accelerometer 440 is used by an application program as an input mechanism to control some functionality of the application program. For example, the application program may be a video game in which a character, a portion thereof, or an object is moved or otherwise manipulated in response to input received via the accelerometer 440. In some configurations, output from the accelerometer 440 is provided to an application program for use in switching between landscape and portrait modes, calculating coordinate acceleration, or detecting a fall. Other uses of the accelerometer 440 are contemplated.

It is contemplated that other sensors such as, for example, a structured light emitter sensor, a magnetometer, an ambient light sensor, a gyroscope, temperature sensors, or shock detection sensors also may be incorporated in the computing device architecture 400.

The structured light emitter sensor is configured to emit a structured light pattern out into the real world and detect reflections of the structured light pattern that are reflected back to the wearable NED device. Based on the reflections and, more particularly, measurable distortions of the structured light pattern, the wearable NED device may map the real-world environment and/or track objects therein.

The magnetometer is configured to measure the strength and direction of a magnetic field. In some configurations the magnetometer provides measurements to a compass application program stored within one of the memory components in order to provide a user with accurate directions in a frame of reference including the cardinal directions, north, south, east, and west. Similar measurements may be provided to a navigation application program that includes a compass component. Other uses of measurements obtained by the magnetometer are contemplated.

The ambient light sensor is configured to measure ambient light. In some configurations, the ambient light sensor provides measurements to an application program stored within one the memory components in order to automatically adjust the brightness of a display (described below) to compensate for low-light and high-light environments. Other uses of measurements obtained by the ambient light sensor are contemplated.

The gyroscope is configured to measure and maintain orientation. In some configurations, output from the gyroscope is used by an application program as an input mechanism to control some functionality of the application program. For example, the gyroscope can be used for accurate recognition of movement within a 3D environment of a video game application or some other application. In some configurations, an application program utilizes output from the gyroscope and the accelerometer to enhance control of some functionality of the application program. Other uses of the gyroscope are contemplated.

According to various configurations, the computer architecture 400 may operate in a networked environment using logical connections to remote computers through one or more networks (not shown). The computer architecture 400 may connect to the network(s) through a network interface unit (NIU) 444 connected to one of the logic boards 408. It should be appreciated that the network interface unit 444 also may be utilized to connect to other types of networks and remote computer systems. The computer architecture 400 also may include an input/output controller 442 for receiving and processing input from a number of other devices, including a keyboard, mouse, or electronic stylus (not shown in FIG. 4). Similarly, the input/output controller 442 may provide output to the display device 432 and/or other displays (e.g., computer monitors, televisions, etc.), a printer, or other type of output device (also not shown in FIG. 4).

Although no connections are shown between the individuals components illustrated in FIG. 4, the components can interact to carry out device functions. In some configurations, the components are arranged so as to communicate via one or more logic boards 408 and/or one or more data links 410.

It should be appreciated any reference to “first,” “second,” etc. items and/or abstract concepts within the description is not intended to and should not be construed to necessarily correspond to any reference of “first,” “second,” etc. elements of the claims. In particular, within this Detailed Description and/or the previous Summary, items and/or abstract concepts such as, for example, computing hardware components and/or subsets of computing hardware components (that make up a singular computing architecture) may be distinguished by numerical designations without such designations corresponding to the claims or even other paragraphs of the Summary and/or Detailed Description. For example, any designation of a “first subset of computing hardware components” and “second subset of computing hardware components” within a paragraph of this disclosure is used solely to distinguish two different subsets of computing hardware components within that specific paragraph—not any other paragraph and particularly not the claims.

FIGS. 2-4 illustrate/describe various alternate embodiments of the NED device(s) and/or wearable computing device(s) disclosed herein. Specific details being illustrated/described with another specific detail or, alternatively, apart from another specific detail is not intended to be construed as a limitation. Thus, any individual detail illustrated in and/or described with respect to any figure herein may be combined in practically any manner with any other individual detail illustrated in and/or described with respect to any other figure herein. Other individual details illustrated and/or described throughout this disclosure shall be interpreted accordingly.

The presently disclosed techniques are believed to be applicable to a variety of practical applications for splitting a computing architecture of a wearable computing device to improve weight distribution of various computing hardware components of the wearable computing device. Aspects of this disclosure are predominantly disclosed in the context of a wearable NED device that has a first subset of computing hardware located forward of a user's head and a second subset of computing hardware located aft of the user's head. While the presently disclosed techniques are not necessarily limited to this specific context, an appreciation of various aspects of the disclosed techniques is best gained through a discussion of examples in this specific aforementioned context. However, the presently disclosed techniques may be applied to other wearable computing devices such as smart watches, biomonitoring equipment, environmental sensor equipment, and so on. These and other variations shall be considered variations that do not depart from the present disclosure.

### EXAMPLE CLAUSES

Example Clause A, a Near Eye Display (NED) device, comprising: a plurality of computing components that are communicatively coupled to form a client computing system; a first housing that encloses a first subset of the plurality of computing components of the client computing system, wherein the first housing supports at least one display device for generating imagery in front of at least one eye of a user; a second housing that encloses a second subset of the plurality of computing components of the client computing system; a support structure having a front end that is mechanically coupled to the first housing and a rear end that is mechanically coupled to the second housing, wherein the support structure is configured to maintain a position of the first housing at a front side of a head of the user and to maintain a position of the second housing at a rear side of the head of the user; at least one data path that is at least partially enclosed within the support structure and that transmits data signals through the support structure to communicatively interconnect: the first subset of the plurality of computing components that is positioned at the front side of the head, and the second subset of the plurality of computing components that is positioned at the rear side of the head.

Example Clause B, the NED device of Example Clause A, wherein the first subset of the plurality of computing components that is positioned at the front side of the head includes a graphics processing unit that is communicatively coupled to the display device.

Example Clause C, the NED device of any one of Example Clause B, wherein the second subset of the plurality of computing components that is positioned at the rear side of the head includes a central processing unit.

Example Clause D, the NED device of any one of Example Clauses A through C, wherein the client computing system includes: a first logic board that is disposed within the first housing at the front side of the head, and a second logic board that is disposed within the second housing at the rear side of the head.

Example Clause E, the NED device of any one of Example Clauses A through D, wherein the at least one data path is a cable ribbon that contains a plurality of coaxial cables that extend through an enclosed region of the support structure.

Example Clause F, the NED device of any one of Example Clauses A through E, wherein the support structure includes one or more flexible straps that encloses the at least one data path.

Example Clause G, the NED device of any one of Example Clauses A through F, wherein the at least one data path is enclosed within a portion of the support structure that extends along a side of the head of the user.

Example Clause H, the NED device of any one of Example Clauses A through G, wherein a center of gravity of the NED device is located in between the first subset and the second subset, and wherein the center of gravity is at least two inches away from the first subset of the plurality of computing components that is positioned at the front side of the head.

Example Clause I, the NED device of any one of Example Clauses A through H, wherein a center of gravity of the NED device is located in between the first subset and the second subset, and wherein the center of gravity is at least one inch away from the second subset of the plurality of computing components that is positioned at the rear side of the head.

Example Clause J, a Head Mounted Device (HMD), comprising: a plurality of computing components that are communicatively coupled in accordance with a computing architecture; a first housing that encloses a first subset of the plurality of computing components, wherein the first housing supports at least one sensor device to capture imagery of a real-world environment surrounding a user; a second housing that encloses a second subset of the plurality of computing components; a support structure that is mechanically coupled to and maintain a physical separation between the first housing and the second housing, wherein the support structure is configured to maintain a position of the first housing at a front side of a head of the user and to maintain a position of the second housing at a rear side of the head of the user; at least one data path that is at least partially enclosed within the support structure and that transmits data signals between the first subset of the plurality of computing components and the second subset of the plurality of computing components.

Example Clause K, the HMD device of Example Clause J, further comprising: a first logic board that is disposed within the first housing at the front side of the head, wherein at least some individual components of the first subset of the plurality of computing components are mounted to the first logic board; and a second logic board that is disposed within the second housing at the rear side of the head, wherein at least some other individual components of the second subset of the plurality of computing components are mounted to the second logic board.

Example Clause L, the HMD device of any one of Example Clauses J through K, wherein the first logic board includes a first socket and wherein the second logic board includes a second socket, and wherein the at least one data path transmits the data signals between the first socket and the second socket.

Example Clause M, the HMD device of any one of Example Clauses J through, wherein the physical separation between the first housing and the second housing results in a center of gravity of the HMD device being: at least two inches away from the first subset of the plurality of computing components that is positioned at the front side of the head, and at least one inch away from the second subset of the plurality of computing components that is positioned at the rear side of the head.

Example Clause N, the HMD device of any one of Example Clauses J through M, wherein the at least one data path is enclosed within a portion of the support structure that extends along a side of the head of the user.

Example Clause O, the HMD device of any one of Example Clauses J through N, wherein the support structure maintains at least five inches of separation between the first housing and the second housing.

Example Clause P, the HMD device of any one of Example Clauses J through O, wherein the at least one data path is a physical data link that includes at least one folded region that resides within the support structure.

Example Clause Q, a Near Eye Display (NED) device, comprising: a first housing enclosing a first subset of computing components, the first subset of computing components including at least a display device for generating imagery within a field of view of a user; a second housing enclosing a second subset of the computing components; a support structure to support the first housing enclosing the first subset of computing components at a front side of a head of the user and to support the second housing enclosing the second subset of computing components at a rear side of the head of the user, wherein the first subset of computing components at the front side of the head and the second subset of computing components at the rear side of the head are communicatively coupled to form a single computing architecture.

Example Clause R, the NED device of Example Clause Q, further comprising at least one data cable that is enclosed within at least a part of the support structure.

Example Clause S, the NED device of any one of Example Clauses Q through R, wherein the at least one data cable includes at least: a first end that is coupled to a first logic board that supports at least some of the first subset of the computing components; and a second end that is coupled to a second logic board that supports at least some of the second subset of the computing components.

Example Clause T, the NED device of any one of Example Clauses Q through S, wherein the first subset of the computing components and the second subset of the computing components are physically separated at least a distance that results in a center of gravity of the NED device being: at least two inches away from the first subset of the plurality of computing components that is positioned at the front side of the head, and at least one inch away from the second subset of the plurality of computing components that is positioned at the rear side of the head.

### CONCLUSION

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A Near Eye Display (NED) device, comprising:
a plurality of computing components that are communicatively coupled to form a client computing system;
a first housing that encloses a first subset of the plurality of computing components of the client computing system, wherein the first housing supports at least one display device for generating imagery in front of at least one eye of a user;
a second housing that encloses a second subset of the plurality of computing components of the client computing system;
a support structure having a front end that is mechanically coupled to the first housing and a rear end that is mechanically coupled to the second housing, wherein the support structure is configured to maintain a position of the first housing at a front side of a head of the user and to maintain a position of the second housing at a rear side of the head of the user;
at least one data path that is at least partially enclosed within the support structure and that transmits data signals through the support structure to communicatively interconnect:
the first subset of the plurality of computing components that is positioned at the front side of the head, and
the second subset of the plurality of computing components that is positioned at the rear side of the head.

2. The NED device of claim 1, wherein the first subset of the plurality of computing components that is positioned at the front side of the head includes a graphics processing unit that is communicatively coupled to the display device.

3. The NED device of claim 2, wherein the second subset of the plurality of computing components that is positioned at the rear side of the head includes a central processing unit.

4. The NED device of claim 1, wherein the client computing system includes: a first logic board that is disposed within the first housing at the front side of the head, and a second logic board that is disposed within the second housing at the rear side of the head.

5. The NED device of claim 1, wherein the at least one data path is a cable ribbon that contains a plurality of coaxial cables that extend through an enclosed region of the support structure.

6. The NED device of claim 1, wherein the support structure includes one or more flexible straps that encloses the at least one data path.

7. The NED device of claim 1, wherein the at least one data path is enclosed within a portion of the support structure that extends along a side of the head of the user.

8. The NED device of claim 1, wherein a center of gravity of the NED device is located in between the first subset and the second subset, and wherein the center of gravity is at least two inches away from the first subset of the plurality of computing components that is positioned at the front side of the head.

9. The NED device of claim 1, wherein a center of gravity of the NED device is located in between the first subset and the second subset, and wherein the center of gravity is at least one inch away from the second subset of the plurality of computing components that is positioned at the rear side of the head.

10. A Head Mounted Device (HMD), comprising:
a plurality of computing components that are communicatively coupled in accordance with a computing architecture;
a first housing that encloses a first subset of the plurality of computing components, wherein the first housing supports at least one sensor device to capture imagery of a real-world environment surrounding a user;
a second housing that encloses a second subset of the plurality of computing components;
a support structure that is mechanically coupled to and maintain a physical separation between the first housing and the second housing, wherein the support structure is configured to maintain a position of the first housing at a front side of a head of the user and to maintain a position of the second housing at a rear side of the head of the user;
at least one data path that is at least partially enclosed within the support structure and that transmits data signals between the first subset of the plurality of computing components and the second subset of the plurality of computing components.

11. The HMD of claim 10, further comprising:
a first logic board that is disposed within the first housing at the front side of the head, wherein at least some individual components of the first subset of the plurality of computing components are mounted to the first logic board; and
a second logic board that is disposed within the second housing at the rear side of the head, wherein at least some other individual components of the second subset of the plurality of computing components are mounted to the second logic board

12. The HMD of claim 11, wherein the first logic board includes a first socket and wherein the second logic board includes a second socket, and wherein the at least one data path transmits the data signals between the first socket and the second socket.

13. The HMD of claim 10, wherein the physical separation between the first housing and the second housing results in a center of gravity of the HMD device being:
at least two inches away from the first subset of the plurality of computing components that is positioned at the front side of the head, and
at least one inch away from the second subset of the plurality of computing components that is positioned at the rear side of the head.

14. The HMD of claim 10, wherein the at least one data path is enclosed within a portion of the support structure that extends along a side of the head of the user.

15. The HMD of claim 10, wherein the support structure maintains at least five inches of separation between the first housing and the second housing.

16. The HMD of claim 10, wherein the at least one data path is a physical data link that includes at least one folded region that resides within the support structure.

17. A Near Eye Display (NED) device, comprising:
a first housing enclosing a first subset of computing components, the first subset of computing components including at least a display device for generating imagery within a field of view of a user;
a second housing enclosing a second subset of the computing components;
a support structure to support the first housing enclosing the first subset of computing components at a front side of a head of the user and to support the second housing enclosing the second subset of computing components at a rear side of the head of the user, wherein the first subset of computing components at the front side of the head and the second subset of computing components at the rear side of the head are communicatively coupled to form a single computing architecture.

18. The NED device of claim 17, further comprising at least one data cable that is enclosed within at least a part of the support structure.

19. The NED device of claim 18, wherein the at least one data cable includes at least:
a first end that is coupled to a first logic board that supports at least some of the first subset of the computing components; and
a second end that is coupled to a second logic board that supports at least some of the second subset of the computing components.

20. The NED device of claim 19, wherein the first subset of the computing components and the second subset of the computing components are physically separated at least a distance that results in a center of gravity of the NED device being:
at least two inches away from the first subset of the plurality of computing components that is positioned at the front side of the head, and
at least one inch away from the second subset of the plurality of computing components that is positioned at the rear side of the head.
